(19) United States
(12) Patent Application Publication
(10) Pub. No.: US 2018/0371924 A1
(43) Pub. Date: Dec. 27, 2018

(54) Additively Manufactured Blisk with Optimized Microstructure for Small Turbine Engines

(71) Applicant: Florida Turbine Technologies, Inc., Jupiter, FL (US)

(72) Inventors: David B Allen, Oviedo, FL (US); Joseph D Brostmeyer, Jupiter, FL (US)

(21) Appl. No.: 16/015,387

(22) Filed: Jun. 22, 2018

Related U.S. Application Data
(60) Provisional application No. 62/525,484, filed on Jun. 27, 2017.

(51) Int. Cl. F01D 5/34; F01D 5/28

(52) U.S. Cl. CPC F01D 5/34; F01D 5/28; F05D 2300/608; F05D 2300/175; F05D 2230/211; F05D 2230/31; F05D 2300/609

(57) ABSTRACT

An integrally bladed rotor in which a hub and a web are formed from a fine grain microstructure using an investment casting process or from metal powder with a HIP process, and a plurality of rotor blades formed from a coarse grain microstructure using a metal additive manufacturing process, where the hub and the web and the rotor blades are formed as a single piece and from the same material.

### CROSS-REFERENCE TO RELATED APPLICATIONS

This application claims the benefit to US Provisional Application 62/525,484 filed on Jun. 27, 2017 and entitled ADDITIVELY MANUFACTURED BLISK WITH OPTIMIZED MICROSTRUCTURE FOR SMALL TURBINE ENGINES.

### GOVERNMENT LICENSE RIGHTS

None.

### BACKGROUND OF THE INVENTION

### Field of the Invention

The present invention relates generally to a gas turbine engine, and more specifically to a blisk for a small gas turbine engine used to power a UAV.

### Description of the Related Art Including Information Disclosed Under 37 CFR 1.97 and 1.98

Small air-breathing gas turbine engines are required for unmanned military applications such as cruise missile propulsion and UAV's. These engines are currently limited in inlet temperature capability by the creep resistance of their rotating components, which are typically blisks (integrally bladed rotor or bladed disks). Current blisks are manufactured either by casting, which produces coarse-grained, equiaxed microstructures, or by machining from forged pancakes, which have finer grained microstructures. A coarse-grained material will have better creep properties than a fine-grained material, but for strength and toughness, a fine-grained material is required. An idealized blisk would have a fine-grained microstructure in the hub and web regions (for high strength and fracture toughness) and a coarse-grained, radially directional microstructure (aligned parallel to the CF loading) in the outer rim and blades, where the temperatures are highest.

A prior art turbine rotor disk is shown in FIGS. 1 and 2 in which individual rotor blades 11 are secured to a slot formed on a rim of a rotor disk 12. This type of attachment is referred to as a dove tail attachment 13, but could also be a fir tree attachment. The rotor blades are made as separate pieces and then secured to the rotor disk. This design is not good for small gas turbine engines due to the gaps formed in the attachment. The size of the gaps do not scale and thus for a small engine the gap size to the airfoil size is relatively large. Thus, for small engines a designer would typically use an integrally bladed rotor or IBR in which the rotor blades and the rotor disk are formed as a single piece and thus no gaps are present. However, design characteristics for an IBR are significantly limited since the IBR is formed from a single piece from the same material in the same production process.

### BRIEF SUMMARY OF THE INVENTION

A Blisk (also referred to as an IBR or Integrally Bladed Rotor) in which a hub and a web is formed from casting or metal powder using a HIP process, and where the blades and outer rim that is exposed to the high temperature gas flow is formed using a metal additive manufacturing (AM) process. The blisk can be formed from an advanced disk alloy developed by NASA Glenn Research Center (NASA GRC) termed “LSHR”, which stands for Low Solvus High Refractory. LSHR is a nickel based superalloy with properties similar to IN100 (a common second-generation aerospace disk alloy) but with improved creep resistance and also with the unique capability of being produced by additive manufacturing. Mechanical test specimens will be produced and tested to evaluate the tensile, creep and fatigue properties of the columnar LSHR material.

The airfoils formed by the additive manufacturing process uses a laser with a high power setting (1 kW laser) such that a columnar microstructure is formed similar to a directionally solidified grain structure in a rotor blade formed from an investment casting process. The higher power causes re-melting of layers beneath the current layer, therefore solidification proceeds along a longer path, giving columnar grains. This is a very coarse columnar structure via AM and will give the rim and blades of the blisk excellent creep properties and thus a higher temperature capability. A blisk for a small gas turbine engine can therefore be produced at a reduced cost and with minimal or no cooling required.

In another embodiment, the hub and web is cast with a ceramic core extending out therefrom to form cooling channels or passages, and the AM parts are then printed over the ceramic core parts. After the blisk is formed from the casting and the AM processes, the ceramic cores can be leached away leaving internal cooling passages. The ceramic cores can also be used to form hollow rotor blades instead of cooling air passages.

### BRIEF DESCRIPTION OF THE SEVERAL VIEWS OF THE DRAWINGS

FIG. 1 shows a section of a turbine rotor disk with rotor blades that are secured to a hub using a dovetail slot assembly of the prior art.

FIG. 2 shows a cross section side view of the prior art rotor disk of FIG. 1.

FIG. 3 shows a section of a blisk with a hub and web formed from a casting with the rotor blades and outer rim surface formed from an additive manufacturing process of the present invention.

FIG. 4 shows a cross section side view of the blisk of FIG. 3.

FIG. 5 shows a flow chart of the process of forming the blisk of the present invention.

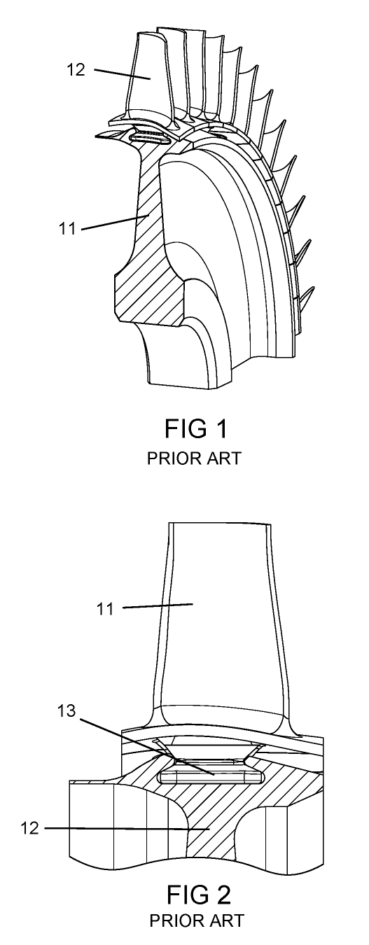

### DETAILED DESCRIPTION OF THE INVENTION

The present invention is a blisk (IBR or Integrally Bladed Rotor) for a small gas turbine engine of the size to propel a UAV. The blisk is formed from the same material but with two different processes. The hub and web are formed by casting or metal power with HIP (High Isostatic Pressure) with a fine-grained microstructure in the hub and web regions (for high strength and fracture toughness) and a coarse-grained, radially directional microstructure (aligned parallel to the CF loading) in the outer rim and blades, where the temperatures are highest.

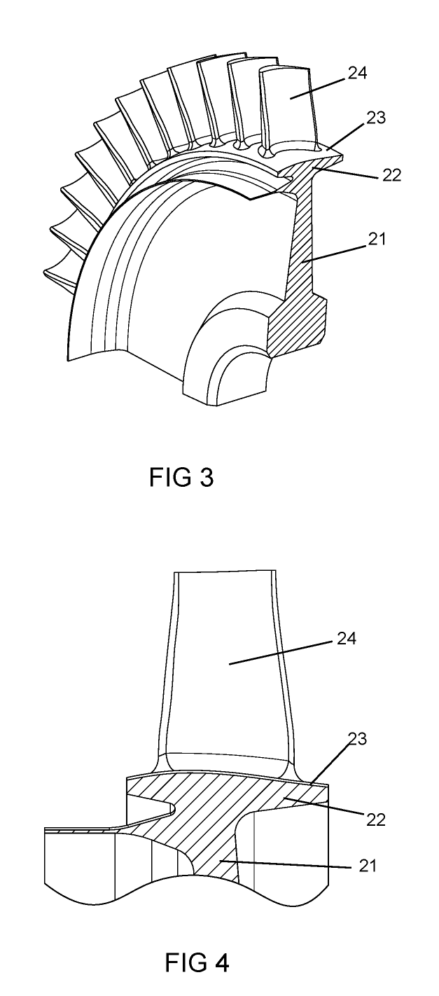

FIG. 3 shows a blisk of the present invention with a hub 21, a web 22, an outer surface 23 of the web, and rotor blades 24 extending from the web 22. The blisk is a one-piece rotor with the hub 21 and the web 22 and the web outer surface 23 and the rotor blades 24 all made from the same material but with different properties resulting from different grain structures. The hub 21 and the web 22 are cast or formed from a metal powder that is compressed using a HIP (High Isostatic Pressure) process which results in a fine grained micro structure that produces high strength and fracture toughness. These properties are required in the hub and web of the blisk. The outer surface 23 of the web 22 and the rotor blades 24 that are exposed to the hot gas stream are formed by an additive manufacturing (AM) process over the cast hub 21 and web 22. The outer surface 23 and the rotor blades 24 are thus printed onto the web 22 to form the IBR. The AM process produces a coarse grain and radially directional microstructure with give the rim and blades of the blisk excellent creep properties and thus a higher temperature capability.

The blisk can be formed from an advanced disk alloy developed by NASA Glenn Research Center (NASA GRC) termed “LSHR”, which stands for Low Solvus High Refractory. LSHR is a nickel based superalloy with properties similar to IN100 (a common second-generation aerospace disk alloy) but with improved creep resistance and also with the unique capability of being produced by additive manufacturing. In another embodiment, the blisk can be formed from IN100.

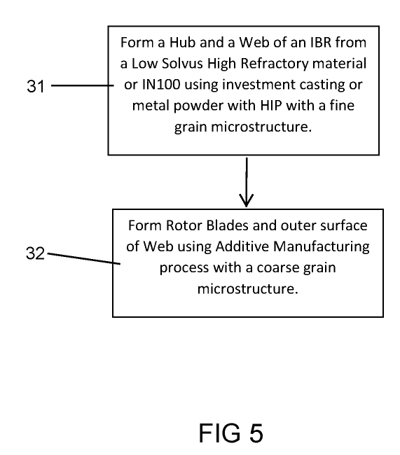

The process of forming the blisk of the present invention (shown in FIG. 5) is to form the hub and the web using an investment casting process or from metal powder with a HIP process to form the hub and the web with a fine grain microstructure for strength (step 31). Then, the outer surface of the web and the rotor blades are formed over the cast hub and web using an AM process (step 32) in order to produce blades with a coarse grain and radially directional microstructure for high temperature resistance.

Claims

We claim the following:

1. An integrally bladed rotor comprising:
a hub;
a web formed outward of the hub;
a plurality of rotor blades extending outward from the web;
the hub and the web and the plurality of rotor blades all formed as a single piece;
the hub and the web being formed from a fine grain microstructure; and,
the rotor blades being formed from a coarse grain microstructure.

2. The integrally bladed rotor of claim 1, and further comprising:
an outer surface of the web being formed from a coarse grain microstructure the same as the plurality of rotor blades.

3. The integrally bladed rotor of claim 1, and further comprising:
the hub and the web and the plurality of rotor blades are all made from the same material but with different properties resulting from different grain structures.

4. The integrally bladed rotor of claim 3, and further comprising:
the material is a Low Solvus High Refractory material.

5. The integrally bladed rotor of claim 3, and further comprising:
the material is IN100.

6. A method of forming an integrally bladed rotor, the integrally bladed rotor having a hub and a web and a plurality of rotor blades, the method comprising the steps of:
forming the hub and the web using an investment casting process or from metal powder with a HIP process; and,
forming an outer surface of the web and the rotor blades using a metal additive manufacturing process.

7. The method of forming an integrally bladed rotor of claim 6, and further comprising the step of:
forming the hub and the web and the rotor blades from the same material.

8. The method of forming an integrally bladed rotor of claim 6, and further comprising the steps of:
forming the hub and the web from a fine gain microstructure; and,
forming the rotor blades with a coarse grain and radially directional microstructure for high temperature resistance.

9. The method of forming an integrally bladed rotor of claim 8, and further comprising the step of:
forming an outer surface of the web with the coarse grain microstructure.

10. The method of forming an integrally bladed rotor of claim 7, and further comprising the step of:
Forming the hub and the web and the rotor blades from a Low Solvus High Refractory material.

11. The method of forming an integrally bladed rotor of claim 7, and further comprising the step of:
Forming the hub and the web and the rotor blades from IN100.
